(19) United States
(12) Patent Application Publication
(10) Pub. No.: US 2004/0027326 A1
(43) Pub. Date: Feb. 12, 2004

(54) System for and method of developing a common user interface for mobile applications

(76) Inventors: Grace Hays, San Jose, CA (US); Florence Perot, Sunnyvale, CA (US); Rabindra Pathak, Cupertino, CA (US)

Correspondence Address: HEWLETT-PACKARD COMPANY, Intellectual Property Administration, P. O. Box 272400, Fort Collins, CO, 80527-2400, US

(21) Appl. No.: 10/213,334

(22) Filed: Aug. 6, 2002

(51) Int. Cl. G09G 5/00; G09G 3/34

(52) U.S. Cl. 345/106; 345/762; 345/760; 345/717

(57) ABSTRACT

A system and method for graphically generating a user interface using software, the software generating a user interface display having a first, second and third area, and including selecting an element to include in the user interface from the first area, determining if the selected element is a common element or a specific element, generating code based on the determination, wherein information associated with the generated code is displayed in the second area, and testing the generated code is performed in the third area.

### RELATED APPLICATIONS

The present application is related to commonly assigned U.S. patent application Ser. No. [Attorney Docket No. 100200590-1] entitled “CREATION OF USER INTERFACES FOR MULTIPLE DEVICES,” and U.S. patent application Ser. No. [Attorney Docket No. 100200597-1] entitled “USER INTERFACE DESIGN AND VALIDATION INCLUDING DYNAMIC DATA,” filed concurrently herewith, the disclosures of which are hereby incorporated by reference in their entireties.

### FIELD OF THE INVENTION

The present invention relates to developing software applications for mobile devices and, more specifically, to the graphic user interface (“GUI”) for software applications.

### BACKGROUND

Mobile devices, such as cellular phones, two-way pagers, radio telephones, PDAs and/or other wireless devices, are quickly becoming popular in many countries around the world. Unfortunately, mobile devices have hardware restrictions (e.g., limited memory, limited storage capabilities, small display screens and restricted input methods). Moreover, different mobile device may have different screen sizes, font, styles and size (if provided for at all), image display capabilities and colors. As a result, developers creating applications for mobile devices must use different markup languages to create a User Interface (UI) appropriate for each mobile device. Currently, there are various methods for a mobile application developer to design a user interface for a mobile application using WML or CHTML. Other markup languages, including XHTML and pocket HTML, may also be used. Some examples follow.

In one mobile application development system, a Graphical User Interface (GUI) tool is not used. This type of development system relies a text editor to create the User Interface (UI) of the mobile application system. The developer must know the correct syntax of both WML and CHTML markup languages and the correct tag placement to develop a UI for both markup languages.

In another mobile application development system, a GUI tool may be used to create the UI. A GUI tool hides markup language programming specifics (e.g., tags) from the developer so that a developer may avoid learning syntax and code for that particular markup language. For example, the ICONVERSE® GUI tool enables a mobile application developer to create, using the GUI tool, UI portions of mobile applications without knowing the tag syntax for the specific languages.

The above-mentioned mobile application design methods are inflexible since they do not allow developers to design and customize applications in multiple markup languages. A developer may want to redesign a UI for each different mobile device. It is desirable to design a single UI for multiple mobile devices.

### SUMMARY OF THE INVENTION

A system and method for graphically generating a user interface using software, the software generating a user interface display having a first, second and third area, and including selecting an element to include in the user interface from the first area, determining if the selected element is a common element or a specific element, generating code based on the determination, wherein information associated with the generated code is displayed in the second area, and testing the generated code is performed in the third area.

### BRIEF DESCRIPTION OF THE DRAWINGS

FIG. 1 is a block diagram of an embodiment of a system for generating a user interface consistent with an embodiment of the present invention;

FIG. 2 shows a flow chart or a method of generating a user interface according to an embodiment of the present invention;

FIG. 3A is an exemplary screen shot of a dialog box generated by initialization of the system shown in FIG. 1;

FIG. 3B is an exemplary screen shot of a user interface display generated by the software shown in FIG. 1; and

FIG. 4 is a flow chart of a method for generating both WML and CHTML UIs according to an embodiment of the present invention.

### DETAILED DESCRIPTION

One type of markup language mobile application developers use is the Wireless Markup Language (WML). WML is designed for mobile devices with small screens and one-hand navigation without a keyboard. WML is scalable from two-line text displays up through graphic screens found on mobile devices, such as smart phones and communicators. Specifications that use WML, such as the Wireless Access Protocol (WAP) specification, are primarily used in the United States. WAP allows users to access information via mobile devices. WAP-enabled mobile devices use graphical displays and enable users to access the Internet using a microbrowser (a browser that can accommodate the limited memory and low bandwidth constraints of wireless devices).

A second type of markup language mobile application developers use is the Compact Hypertext Markup Language (CHTML). CHTML is a simpler form of Hypertext Markup Language (HTML) and may be used on mobile devices with limited hardware and software restrictions. CHTML does not support tables, events, timers or templates. Services, such as the I-MODE® service available from NTT DoCoMo, use CHTML. I-MODE® enables a user to receive multimedia services, access information (e.g., stock tickers, weather, traffic information) and communicate with other users (e.g., e-mail or a real time communications, such as instant messenger).

Both WML and CHTML use “tags” to mark a section of a document with a formatting command. The tags enable a wireless application developer to indicate the beginning of a new section. For example, to include a title tag using CHTML, a developer may include “<TITLE>TITLE OF APPLICATION</TITLE>” as part of the CHTML code. Each markup language has its own set of rules to implement tags.

WML and CHTML have different nuances and capabilities. A wireless application developer that develops an application that works in both Japan and the United States needs to create the application using both WML and CHTML markup languages (for WAP and I-MODE®, respectively). Even so, not all tags are available in WML and CHTML. For example, WML provides a “table” concept that allows a mobile application developer to define a table in terms of rows and columns. CHTML does not provide a “table” construct.

Generally, there are two parts to every mobile application. The presentation layer part of the UI also known as the “front-end” and the “processing” part of the UI, also known as the “back-end.” The example of a mobile application allows a user to locate books based on location, the front-end may be the text displayed on the mobile device screen. The front ends also provides multiple screens, such as the title screen of the application (e.g., “Bookstore Application”), the zipcode input box screen (e.g., “Enter current zipcode”) and the selectable list of bookstores screen. Each screen may also include multiple elements. An element is a particular aspect or component of the UI, such as check boxes, radio buttons, lists or any other information to be included and displayed to the user in the UI.

In the above-identified example, the back-end may refer to JAVA® Server Pages (JSP) that process information received from the front-end that queries remote databases for bookstore information. The back-end may receive information from a remote database and forward the information to the front-end for display (e.g., a list of selectable restaurants).

An embodiment consistent with the present invention provides software to develop a mobile application for mobile devices that are programmed by different markup languages, such as CHTML, WML or HTML. The software enables a mobile application developer to design a single UI interface capable of running on multiple mobile platforms and devices. To do so, a mobile application developer may drag and drop UI elements from a UI element “palette” section to a project view section of the software. The palette may include a list of elements available to display in the UI. For example, an element may be a checkbox, choice box or radio button. The software may automatically generate WML, CHTML or HTML code based on the selected UI element. The software also contains an embedded simulator area where a mobile application developer may validate and test the generated WML, CHTML, or HTML code. It will be understood that the software may use an embedded simulator, an integrated simulator or an external simulator to validate and test the generated code.

WML and CHTML differ in both capability and in syntax. If the mobile application developer wants to place a “submit button” element in the UI for both a CHTML mobile device and a WML mobile device, the code that is ultimately generated may be different. For example, the code to place a submit button element in WML code may be:

<do label = “label” type =“accept”

<go method=“post” href=“url”>
</go>

<do>

The code to place a submit button element in cHTML code may be:

<FORM method=“post” action=“url”>
<INPUT type = “submit” value = “label”> <BR>
</FORM>

Some elements available in WML are not available in cHTML (or vice versa). For example, WML includes a “table” element that displays a table in terms of rows and column in the UI. CHTML is not able to interpret the “table” element. Also, for example, cHTML includes a “checkbox” element that displays a checkbox in the UI. In such cases, an embodiment of the present invention transforms code associated with elements that are not available in one language into code of another language to simulate the missing equivalent construct or provide a substitute. For example, in WML a table may be represented as follows:

<table align = “alignment” columns = “columnCnt”/>
<tr>

<td>“text1”</td>
<td>“text2”</td>

</tr>
</table>

The transformed code in CHTML may be:

<P align=“alignment”>
“text1” “text2” <BR>
</P>

The transformation code may be stored in a database. As more elements are created in WML and/or CHTML, more elements may be transformed and stored in the database. Additional examples of generated code and transformed code may be found in Appendix A attached hereto.

FIG. 1 is a block diagram of computer 100 suitable for practicing methods and systems consistent with an embodiment of the present invention for use by a mobile application developer. Computer 100 may be a suitable Personal Computer (PC) or workstation capable of storing and executing program code consistent with the present embodiment. Thus, computer 100 includes memory 101, secondary storage device 103, CPU 105, video display 106 and input/output device 107. Memory 101 has stored therein software 102, that generates and transforms WML and CHTML code to create UIs for various mobile devices based on UI elements. Generated code as used herein is code that is associated with an element in a markup language. Transformed code is code that is generated by software 102 to simulate an element in a markup language. The transformed code may be generated by software 102 based on a dictionary of generated code referencing corresponding transformed code as stored in a database. The stored transformed code may be created by a mobile application developer to simulate a particular construct missing from a target markup language. Software 102 also enables a mobile application developer to immediately simulate code in an mobile device simulator. The mobile device simulator may be an embedded simulator, an integrated simulator or an external simulator.

Secondary storage device 103 may include database 104 that may store code and code transformations associated with each UI element and each markup language. For example, database 104 may include WML code and CHTML code that displays text on a UI. Database 104 may also include transformed code. For example, database 104 may store WML code to create a table and together with the corresponding transformed CHTML code. Input/output device 107 may be a keyboard, mouse or other input or output device.

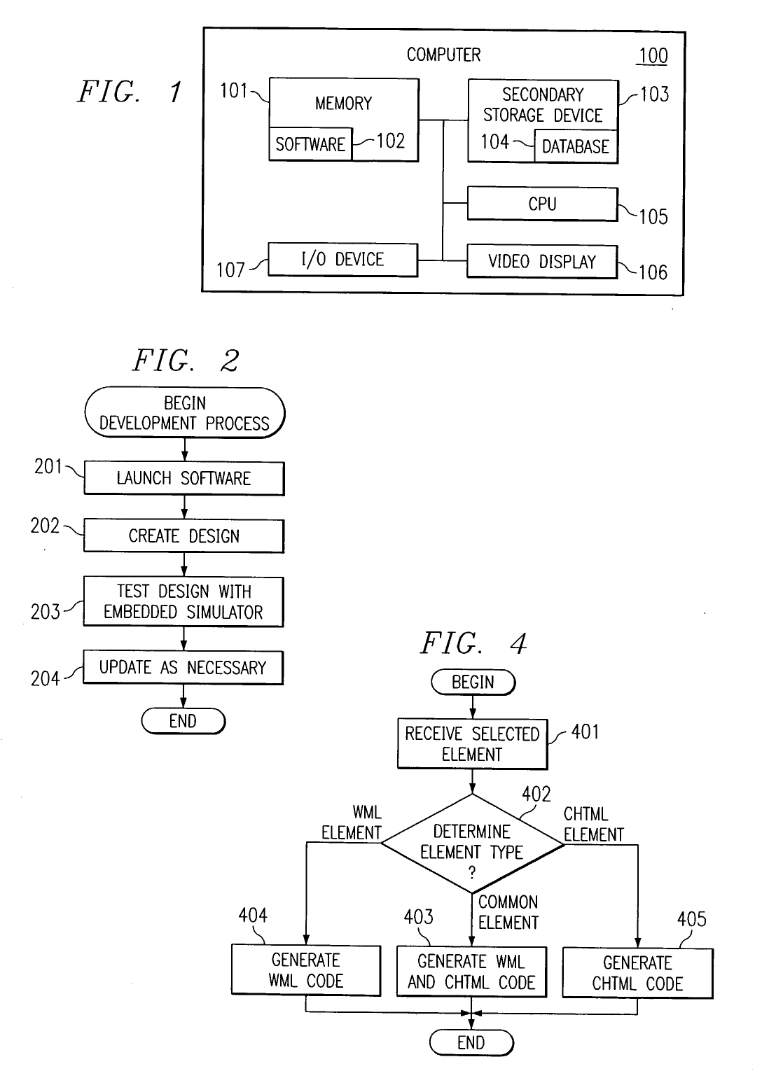

FIG. 2 is a flow chart consistent with one embodiment of the present invention. In Step 201, software 102 may be initiated, for example, by “double-clicking” (using a mouse) on an icon associated with software 102 or typing in the software name from a command line. Note that software 102 may be initiated using other methods, such as automatically executing the software during computer 100s startup sequence.

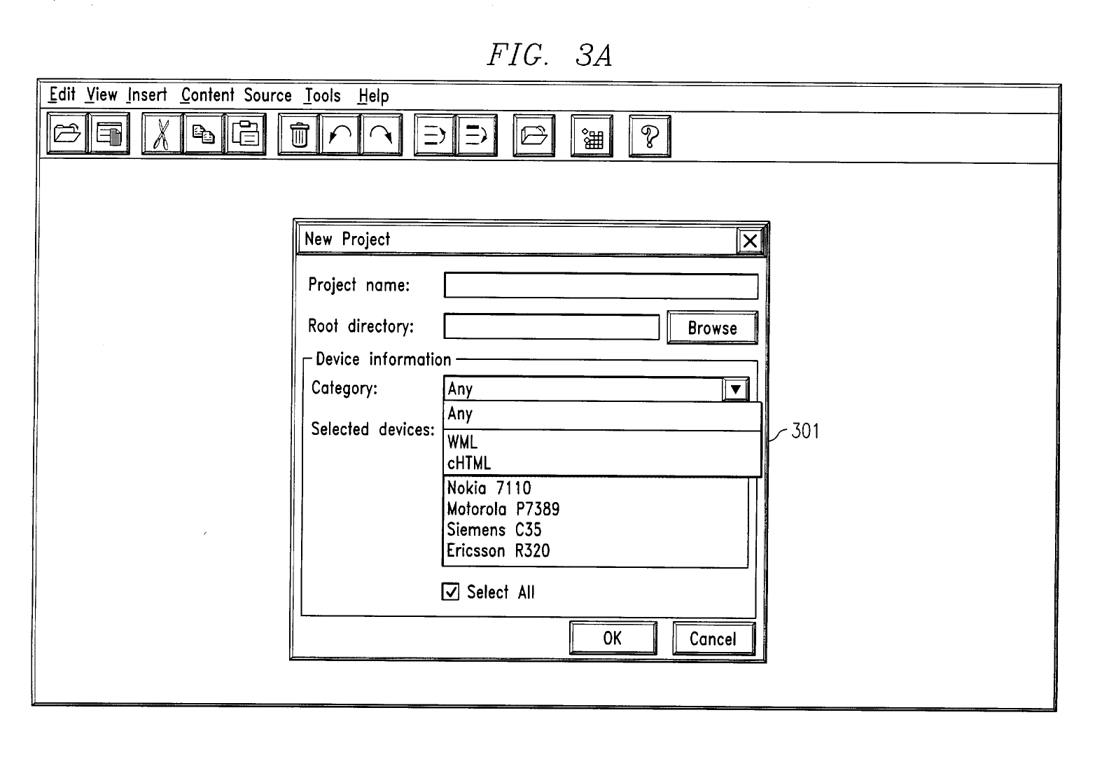

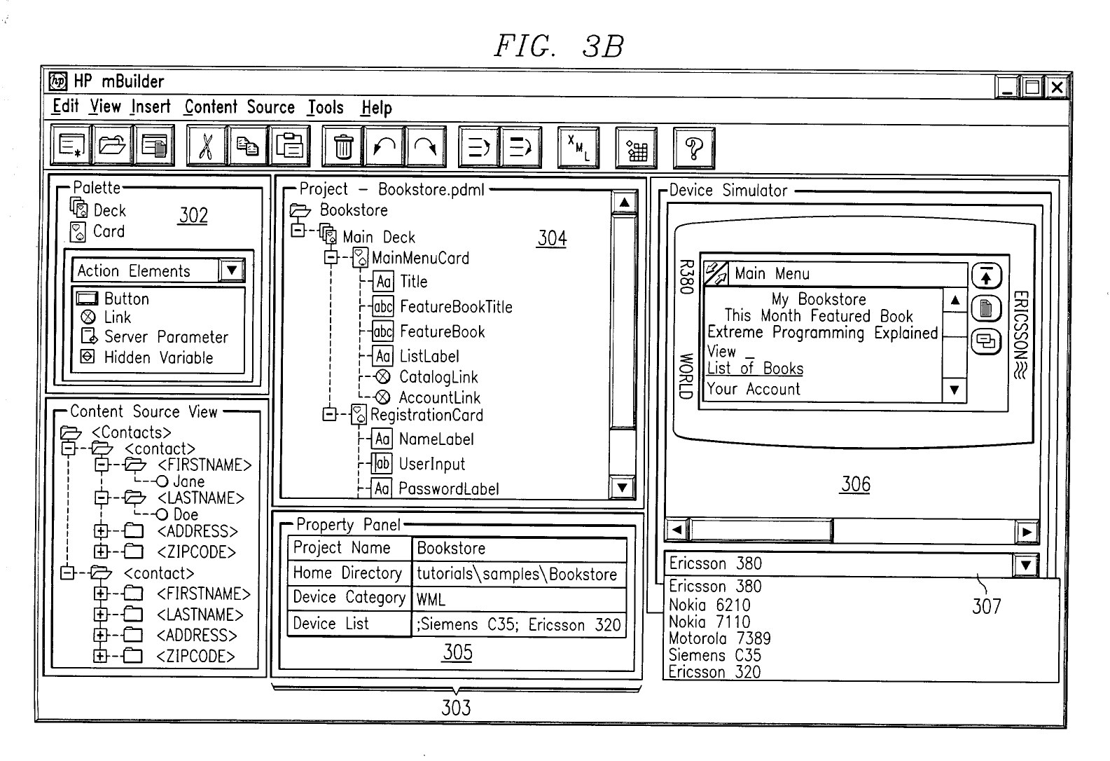

FIG. 3A is an exemplary view of a screen display generated by software 102 once it has been initialized. In FIG. 3A, a mobile application developer may initiate a new project and select the types of mobile devices that the developer will create a UI. Dialog box 301 includes fields to specify a project name, a project directory, a device category and device targets. The device category includes a list of markup languages, such as WML, or CHTML, for which software 102 will generate code. The “selected devices” menu includes a list of mobile devices or targets on which code may be simulated.

Once the mobile application developer selects the mobile device targets from dialog box 301, the developer may use software 102 to create and design a UI for all selected mobile devices (step 202). FIG. 3B is an exemplary view of a design user interface display generated by software 102 during the design mode of step 202. UI palette 302 enables a developer to chose different UI elements to place in working space 303. Palette 302 may include different types of UI elements, such as action elements, input elements, display elements and markup language unique or specific elements. Action elements are elements that allow a user to submit data to a back-end system, such as, for example a “submit data” element. Action elements may also be links between display pages and/or cards. Input elements are elements that allow a user to select items, such as, for example, check boxes, radio boxes or yes/no dialog boxes. Display elements are elements that display data in the UI, such as, for example, text display, list display, tables or labels. Specific elements are elements that are available only for a particular markup language, such as the “event,” “template” or “timer” elements, which are WML-specific elements, and the “blink” and “marquee” elements which are CHTML-specific elements. The code associated with specific elements are unique to a markup language and may not be directly transformed into a different markup language since the functionality of a specific element is available only in one markup language.

Working space 303 includes project tree area 304 and property panel area 305. Information associated with generated code and transformed code may be displayed in working space 303, such as property information, identification information, or markup language syntax. A developer may use project tree area 304 to place UI elements that are dragged from UI palette 302. A developer may use property panel area 305 to specify additional information (e.g., properties) for each UI element placed in the project tree area (e.g., title to be displayed on the screen or width of element). An embedded, integrated or external simulator may be used to simulate how generated (and transformed) code will function on a mobile device. The simulator enables a developer to see in real time via output box 306 what the UI will look like on a particular mobile device. That is, output box 306 may show the output generated by the simulator. The developer may select a particular simulator from a selection of mobile devices in list box 307 (e.g., select WML simulator for a WML enabled mobile device). This enables a developer to simulate UIs on different mobile devices. Note that where an embedded simulator is discussed herein, external or integrated simulators may also be used.

In one embodiment of the present invention, a mobile application developer may “drag” an element from UI palette 302 and “drop” the selected element in project area 304. The “drag and drop” allows a developer to design a UI of the mobile application. For example, in creating a title for a bookstore mobile application, the developer may take a title element and drag it to project area 304. The developer may then type “bookstore” in property panel area 305 associated with title element. In creating a page displaying a list of bookstores in a specified area in the UI, the developer may select a list box element and drag the list box element to project area 304. The developer may also associate additional information with the list element placed in property panel area 305. In doing so, the generated CHTML code and the transformed WML code for the list box element may be modified to include the additional information. For example, the developer may enter in parameters for the list element in property panel area 305.

As the mobile application developer adds UI elements to working space 303, the developer may test the UI with an embedded simulator (step 203). Software 102 may display the results of the simulation in output box 306. Once the UI is tested with an embedded simulator, mobile application developer may update the UI as necessary (step 204), for example, to further modify the UI by adding, deleting or changing the elements in project area 304 or property panel area 305.

FIG. 4 is a flow chart consistent with an embodiment of the present invention wherein software 102 generates and/or transforms WML and CHTML code. First, software 102 receives a selected UI element in project area 304 (step 401). For example, a mobile application developer may select a “check box” UI element to be included in the UI of a mobile application. The developer may drag and drop the selected UI element into project area 304. Next, software 102 determines if the selected element is a common element or a specific element (WML element or CHTML element) (step 402). A common element is an element with code applicable to multiple markup languages (e.g, WML and CHTML). Software 102 may query database 104 to obtain the element's properties. If the element's properties indicate that the element is a common element, then software 102 may generate and/or transform the WML and the CHTML code, as necessary. (step 403). Software 102 may query database 104 and obtain the WML and CHTML code associated with the common element. If the selected element is not a common element (step 402), software 102 may determine if the selected element is a specific WML element or a specific CHTML element. If the element is a specific WML element, then software 102 generates WML code (step 404). Software 102 may query database 104 and obtain the generated WML code. Alternatively, if the selected element is a specific CHTML element, then software 102 may generate CHTML code (step 405).

Appendix A: Common Element Description

All attributes in elements are visible and can be modified by the viewer except the ID attribute and the element counters in the Project Element.

In general, use alpha/numeric characters for attribute definitions since using special characters in attribute entry fields (e.g. &, %, “, $, etc.) may not render consistently or correctly between simulators. For example, a button label like “&myLabel” will cause an error in the microbrowser of a WML device. Exceptions will be noted for specific attributes in the attribute tables below.

The WML and cHTML transformation may show “bounding” tags like <BODY> in cHTML to show tag containership. In the example of cHTML when the markup is actually generated there would not be multiple <BODY> tags within a single card.

To update Dynamic Data Source attributes in the elements below, the developer can either:

1) Enter the XML schema information directly into the Dynamic Data Source attribute field in the Attribute Panel.

2) Drag and Drop (DnD) the data item from the Content Source View onto the smart element icon in the Project View. mBuilder will automatically update the attribute. If there are multiple Dynamic Data attributes in a single element (see “menu” element section below) the developer will have to set the xpath directly in the Property Panel.

1. <button>

Description: This element is used to define a button. For action=“submit”, a <button> can contain one or more Server Parameter elements. A <button> can be contained in a <card>

When Used: A button is used to invoke the action specified. For example, to send user input from the device to the server, the developer would provide a button with Action Type=“submit”.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this Element Label associated with this button |
| | element in the Project View panel of mBuilder. |
| Button Label | Label displayed to the user for this button. |
| | Note: label should not exceed 6 characters or it may not |
| | display. |
| ButtonType | REQUIRED: Specifies the action to be invoked. Valid |
| | options: submit\|reset\|prev\|next. Default: submit. |
| | Note: If the “submit” type is specified, all input |
| | variables contained in the card will be sent to the server. |
| | To send additional variables from other cards within the |
| | same deck, use the ServerParameter element. |
| | Note: If the “reset” type is specified all input items are |
| | cleared. |
| | Note: For cHTML the “prev” option is not supported. |
| Hyperlink | REQUIRED: Holds the URL the browser should be |
| | redirected to if a “submit” or “next” action is specified in |
| | the “action” attribute. |

WML transformation

| 1) | If the “submit” action is specified the WML translation will include the |
|---|---|
| | <postfield> tags needed to transmit variable information for the card to |
| | the server. |
| | Note: |
| | <do label = “label” type = “accept”> |

<go method=“post” href =“url”>
<postfield name=“name” value=“value”/>
......

</go>

| | </do> |
|---|---|
| Note: | Since <menu> is a list of links, there is no need to send this variable |
| | value to the server. |
| 2) | If the “next” action is specified: |
| | <do label = “label” type = “options 1”> |
| | <go href = “url”/> |

<go/>

| | </do> |
|---|---|
| 3) | If the “prev” action is specified with no url: |
| | <do label = “label” type = “prev”> |

<prev/>

| | </do> |
|---|---|
| 4) | If the “prev” action is specified with url: |
| | <do label = “label” type = “prev”> |
| | <go href = “url”/> |

<go/>

| | <do> |
|---|---|
| 5) | If the reset” action is specified all input variables in the card are |
| | cleared: |
| | <do label = “label” type = “reset”> |
| | <refresh> |

<setvar name=“variable1” value” “/>

....

</refresh>
</do>

cHTML transformation

| | |
|---|---|
| 1) | If the “submit” action has been specified: |
| Note: | Intially, there will be one <FORM> created per card. The “url” |
| | specified in the <button> attribute will be used by the cHTML |
| | <FORM>tag. |
| | <FORM method=“post” action = “url”> |
| | <INPUT type = “submit”value = “label”> <BR> |
| | </FORM> |
| 2) | If the “reset” action has been specified: |
| | <INPUT type = “reset” value = “label”> <BR> |
| 3) | If the “next” action was specified, a link can be created. |
| | <A href= “url”>“label”</A><BR> |
| Note: | If the “prev” action was specified, no cHTML code will be |

generated. The user can either “scroll up” on his iMODE device to see the previous page, or
use the “back” hotkey on his iMODE device to go to the previous URL.

2. 2. <card>

Description: This element is used to store card level information. One or more of the all of the common elements defined for mBuilder can optionally be contained within a card except for <deck>, <listItem>, <menuItem>, <radioButton>, <checkbox>, <serverParmater>. If WML specific elements are being used (see Appendix B), an <event> or a single WML <timer> element can be contained per <card>. One or more <card> elements can be contained in a deck.

Card ID and Element Label should be the same, and both should not be empty. If the value of either one changes, the other should be updated to reflect the change.

When Used: A card is used to receive input, or display data to the user.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this card element in the |
| | Project View panel of mBuilder |
| Card ID | REQUIRED: Card ID can be referenced within a url |
| | attribute to redirect the browser to this card for |
| | navigation purposes. |
| Title | The text in this field is displayed as a title for the page |
| | created. |
| | Note: not all WAP devices will display this title. |

WML transformation

<card id = “cardID” title = “title”>

......

</card>

cHTML transformation
<FORM>

......

<H1><A name=“cardID”>“title”</A></H1>
</FORM>

3. <checkbox>

Description: This element is used to define a <checkbox> item. To dynamically display a list of checkboxes to the user, use <checkboxGroup>.

Note:

1) For cHTML, an actual “checkbox” is visible to the user with this element. Since WML does not implement a checkbox, only the title is displayed for each selection in most simulators.

2) <checkbox> must be contained with a <checkboxGroup>, and zero or more <checkbox> elements can be contained in a <checkboxGroup>.

3) Title and Element Label should be the same, and both should not be empty. If the value of either one changes, the other should be updated to reflect the change.

When Used: Checkbox should be used if:

1) The UI presented to the developer should visually look like a checkbox vs. a multiple list selection.

2) The user is allowed to select one or more item from the items available in the <checkboxGroup>.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this element in the |
| | Project View panel of mBuilder. |
| Title | REQUIRED: Text to be displayed for this checkbox |
| | element. |
| Checked | Indicates whether the <checkbox> is selected. Valid |
| | options: true\|false. Default: false |
| Return Value | Value to be stored in “Variable Name” attribute of this |
| | checkbox's checkboxGroup if this checkbox is selected. |

WML transformation

<option value = “value”>“title”</option>

cHTML transformation

see <checkboxGroup> for transformation.

4. <checkboxGroup>

Description: This element is used as a container for zero or more <checkbox> elements. This element is used if the user is allowed to select one or more items from the group of items displayed. To dynamically display a group of checkboxes to the user, store the Xpath for the text/value pairs of the checkboxes to be displayed in the Dynamic attributes described below.

Nothing is displayed on the Simulator for a checkboxGroup element. Only static data stored in <checkbox> elements are displayed. To validate how dynamic data is displayed, use sample data in <checkbox> elements contained in a <checkboxGroup>. This static data will not be displayed at runtime.

When Used: checkboxGroup should be used if:

1) The UI presented to the developer should visually look like a checkbox vs. a multiple list selection. Note: for WML, checkbox elements may be rendered as a multiple selection list on some devices. To allow for the same “look and feel” on both WML and cHTML devices please refer to the ChoiceBoxGroup element definition.

2) The user is allowed to select one or more item from the items available in the <checkboxGroup>.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this element in the |
| | Project View panel of miBuilder. |
| Variable Name | REQUIRED: Name to store the selected <checkbox> |
| | “Return Value” in. Default: aName |
| Dynamic Text | If a group of checkboxes are to be dynamically |
| Source | displayed, this attribute holds the xpath (schema) of the |
| | “Title” attribute for each checkbox to be displayed. |
| | Note: If this attribute has been filled, static data in the |
| | checkbox elements contained in this will be visible in the |
| | Smart Canvas for UI validation, but will not be seen at |
| | runtime. |
| Dynamic Value | Holds the xpath (schema) of the “Return Value” attribute |
| Source | if a group of checkboxes are to be dynamically supplied. |
| | Note: If this attribute has been filled, static data in the |
| | checkbox elements contained in this will be visible in the |
| | Smart Canvas for UI validation, but will not be seen at |
| | runtime. |

WML transformation

For WML all <checkbox> elements must be contained within the same <select> tag. A <checkbox> transformation (i.e. WML <option> tag) is included in the transformation below for completeness. “value” should have the same value as that of the selected <checkbox>s. The “multiple” tag attribute is “true”.

<select name = “name” ivalue= “[index of the selected <checkbox>s
separated by semicolon]” multiple=“true”>
<option value = “value”>“title”</option>

.....

</select>

cHTML transformation

For cHTML all <checkbox> elements will be contained within the same <FORM> tag which was generated at the <card> level. Note: The same “name” value taken from the “name” attribute in <checkboxGroup> is used for every <checkbox> transformation.

The cHTML “checked” attribute is only used for the cHTML <INPUT> transformation whose “checked” attribute is “true”.

<INPUT type =“checkbox” name=“name” value=“value”
checked>“title”<BR>

5. <choicebox>

Description: This element is used define a choice box item. To dynamically display a list of choiceboxes to the user, use <choiceboxGroup>.

Note:

1) <choicebox> must be contained within a <choiceboxGroup>

2) Title and Element Label should be the same, and both should not be empty. If the value of either one changes, the other should be updated to reflect the change.

When Used: Choicebox should be used if: The UI presented to the developer should visually look similar in both WML and cHTML displays. The rendering will typically look like a multiple list selection.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this choicebox element |
| | in the Project View panel of mBuilder. |
| Title | REQUIRED: Text to be displayed for this choicebox |
| | element. |
| Return Value | Value to be stored in “Variable Name” attribute of this |
| | choicebox's choiceboxGroup if this item is selected. |

WML transformation

<option value = “value”>“title”</option>

cHTML transformation

Note: the cHTML key word “selected” used below is only used on the <choicebox> whose “value” attribute matches the value of the “default” attribute specified in this <choicebox>'s corresponding <choiceboxGroup> element.

<OPTION value =“value” selected>“title”

6. <choiceboxGroup>

Description: This element is used as a container for one or more <choicebox> elements. To dynamically display a group of choice boxes to the user, store the Xpath for the title/value pairs of the checkboxes to be displayed in the Dynamic attributes described below.

Note: Nothing is displayed on the Simulator for a choiceboxGroup element.

Only static data stored in <choicebox> elements are displayed. To validate how dynamic data is displayed, use sample data in <choicebox> elements contained in a <choiceboxGroup>. This static data will not be displayed at runtime.

When Used: choiceboxGroup should be used if: The UI presented to the developer should visually look similar on most WML and cHTML devices.

(Typically a multiple selection list). A choiceboxGroup can be defined to allow only one selection, or multiple selections by using the “Allow Multiple” attribute.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this choiceboxGroup |
| | element in the Project View panel of mBuilder. |
| Variable Name | REQUIRED: Name to store the selected <choicebox> |
| | “value” in. Default: aName |
| Display Size | Represents the drop down menu size for cHTML. |
| | Ignored for WML. Valid values are empty or any |
| | number. Default: empty. |
| Default | Holds the initial selection of <choicebox> elements when |
| Selection | this <choiceboxGroup> is first displayed. Valid values: |
| | empty, any number, or any number separated by |
| | semicolon. Default: 1 |
| Allow Multiple | Indicates whether multiple <choicebox> elements can be |
| | selected. |
| | Valid options: true\|false. Default: true |
| | NOTE: If multiple selections are allowed, multiple |
| | “values” separated by a “;” from the selected |
| | <ChoiceBox>s will be stored in the “name” attribute of |
| | <ChoiceBoxGroup>. |
| Dynamic Text | Holds the xpath (schema) of the Title attribute for those |
| Source | choiceboxes to be dynamically displayed with this |
| | choiceboxGroup. |
| | NOTE: If this attribute has been filled, static data in the |
| | choicebox elements contained in this will be visible in |
| | the Smart Canvas for UI validation, but will not be seen |
| | at runtime. |
| Dynamic Value | Holds the xpath (schema) of the Return Value attribute of |
| Source | choiceboxes to dynamically displayed with this |
| | choiceboxGroup. |
| | NOTE: If this attribute has been filled, static data in the |
| | choicebox elements contained in this will be visible in |
| | the Smart Canvas for UI validation, but will not be seen |
| | at runtime. |

WML transformation

All <choicebox> elements must be contained within the same <select> tag. A <choicebox> transformation (i.e. WML <option> tag) is included in the transformation below for completeness. If “Allow Multiple” is not selected, don't include ‘multiple=false’ because that's the default behavior.

<select name = “name” ivalue=“default” multiple = “multiple”>
<option value = “value”>“title”</option>

.....

</select>

cHTML transformation

All <choicebox> elements must be contained within the same <select> tag. If displaySize is not empty, include the “size” attribute, otherwise don't include it. If there are ten elements in the <choiceboxGroup>, and the size is set to 3, on the cHTML browser, you will get a list with 3 items displayed and a scrollbar to see more elements. This is very space-conscious when the page has many items. Note: Add “selected” attribute in the <option> tag if the <choicebox> is selected according to the value in the “Default Selection” attribute of the <choiceboxGroup>. Also, the cHTML “multiple” keyword is only used if the “multiple” attribute is set to “true”. A <choicebox> transformation (i.e. <option> tag) is included in the transformation below for completeness.

<SELECT name=“name” size=“displaySize” multiple>

<OPTION value =“value” selected>“title”
....

</SELECT>

7. <deck>

Description: This element is used to store information that pertains to all of the cards in this deck. One or more cards can be contained within a deck. For WML, a deck and its cards are separate, but related entities. cHTML, deck and card information for all cards in the deck are represented by a single cHTML page. For WML only, a “template” element can optionally be contained in a deck. See Appendix B for more information. One or more <card> elements can be contained per deck, but it is suggested the developer not define too many cards per deck due to the limited memory capacity of WAP and IMODE devices.

When Used: A deck is used to group associated cards together. Cards are usually grouped if they can operate independently from the server within the deck.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this deck element in |
| | the Project View panel of mBuilder. |
| HTTP Header | Property name specified as an HTTP header. |
| Name | |
| HTTP Header | Property value for the property specified in the httpEquiv |
| Value | attribute. |
| Base Path | Designates a URL as the base path to use if an explicit |
| | URL is not specified: This attribute is ignored in WML. |
| Access Domain | Holds the domain suffix of allowed referring pages. |
| | Default is the current deck's domain. This attribute is |
| | ignored in cHTML. |
| Content Source | Holds the content source (i.e. sample XML file) for this |
| | deck. |
| | Note: Not provided in Beta Release. Do not document. |

Note: the examples below assumes a single entry for both “httpEquiv” and “accessDomain” attributes. If multiple entrys are allowed by mBuilder from the developer, separate <meta> and <access> tags will have to generated per item.

WML transformation

<wml>
<head>
<meta content = “headerValue” http-equiv=“headerName” />
<access domain = “accessDomain” />
</head>
</wml>

cHTML transformation

<HTML>
<HEAD>
<BASE href=“basePath”>
</HEAD>
<BODY>
<META http-equiv=“headerName” content=“headerValue”>
</BODY>
</HTML>

8. <hiddenVariable>

Description: This element is used to specify a <hiddenVariable> to be sent to the server. The name and value of a hidden variable can be specified dynamically by storing the Xpath for the name and value in the Dynamic Data attributes defined below.

Note:

1) A <hiddenVariable> element must be contained in a <card> element. Multiple <hiddenVariable> elements can be contained within a single <card>.

2) A <hiddenVariable> should be inserted before any non-event element within a <card>, i.e. <event> (VWL-specific element> and <hiddenVariable> have higher precedence over other elements.

When Used: A hidden variable is used if the developer does not want the variable or its value to be visible to user. An example of a hidden variable might be a cookie or another form of user id.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this element in the |
| | Project View panel of mBuilder. |
| Variable Name | REQUIRED: Name of variable to be passed to server. |
| | Default: aName |
| Return Value | REQUIRED: Value to be assigned to “Variable Name” |
| | attribute when passed to server. Default: aValue |
| | NOTE: For WML devices, the name of the variable |
| | stored in the “Variable Name” attribute of |
| | <hiddenVariable> can also be stored in this “Return |
| | Value” attribute. If this is done, the server will receive a |
| | name/value pair which contains the Variable Name, and |
| | the contents of the Variable Name. This type of |
| | functionality is not supported on cHTML. For cHTML, |
| | the name/value pair sent to the server will be Variable |
| | Name and Variable Name. |
| Dynamic Value | Holds the xpath (schema) of the “Return Value” |
| Source | attribute. |
| | NOTE: If this attribute has been filled data stored in the |
| | Return Value attribute will not be used at runtime. |

WML transformation

1. A WML “onenterforward” intrinsic event with <refresh> task type will be generated for all the <hiddenVariable> elements within a <card>. A <setvar> tag will be generated for each <hiddenVariable>. If the <card> element which contains the <hiddenVariable> also contains a <button> with attribute type=“submit”, a <postfield> will be embedded within the <go> tag generated for the <button> element, otherwise the <hiddenVariable> is ignored. The translation below includes the <button> translation for completeness. See the <button> element description for more information.

<onevent type=“onenterforward”>

<refresh>

<setvar name=“name” value=“value”>
<setvar name=“name1” value=“value1”/>

</refresh>

</onevent>

If there is a “submit” button, we will add the following extra transformation.

<do label = “label” type = “accept”>

<go method=“post” href = “url”>
<postfield name=“name” value=“value”/>
<postfield name=“name1” value=“value1”/>
......

</go>
</do>

2. If both the “name” and “value” attributes contain the same variable name, the contents of the variable name stored in the “value” attribute will be passed to the server. Being able to put a variable name into the “value” attribute of <hiddenVariable> is provided so the contents of a WML variable can be passed to the server. Examples are:

a) The variable stored in the “name” attribute for the <textInput>, <menu>, or <radio> elements.

b) The variable stored in the “title” attribute for the <menuItem> element. Transformation is:

<onevent type=“onenterforward”>

<refresh>

<setvar name=“name” value=“value”>
<setvar name=“name1” value=“value1”/>

<refresh>

</onevent>
<do label = “label” type = “accept”>

<go method=“post” bref = “url”/>
<postfield name=“name” value=“$value”/>
<postfield name=“name1” value=“$value1” />

</go>

</do>

cHTML transformation

1. An <INPUT> tag is generated for each <hiddenVariable> element. Since the <hiddenVariable> element must be contained in a <card> element, the <INPUT> tag will be included within the cHTML <FORM> tag generated for the <card> element.

Note: a cHTML “hidden” attribute is used here since <hiddenVariable> is used to pass additional info to the server, though it won't be displayed on the screen.

<INPUT type=“hidden” name=“name” value=“value”>

2. If both the “name” and “value” attributes contain the same variable name, this <hiddenVariable> element will not be translated (i.e. it will be ignored) for cHTML. Being able to put a variable name into the “value” attribute of <hiddenVariable> is provided so the contents of WML <input> or <select> tags can be sent to the server. Since cHTML can pass <INPUT> and <SELECT> items directly through the cHTML <FORM> tag this capability is not needed for cHTML.

9. <image>

Description: This element is used to display an image. One or more <image> elements can be contained per <card>.

When Used: To display an image on the display screen.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this image element in |
| | the Project View panel of mBuilder. |
| Source | REQUIRED: image source Default: mBuilder will |
| | either provide a default icon. |
| Alignment | Indicates vertical alignment. Valid options: top\| |
| | middle\|bottom. Default: bottom. |
| Height | Height of image specified as a percentage based off of |
| | availablevertical space. |
| Width | Width of image specified as a percentage based off of |
| | available horizontal space. |
| Vertical Space | Amount of space above and beneath the image specified |
| | as a percentage based off available vertical space. |
| | Default: 0 |
| Horizontal | Amount of space on either side of the image specified as |
| Space | a percentage based off available horizontal space. |
| | Default: 0 |
| Text | REQUIRED: Alternative text to display if the device |
| Alternative | cannot display the image. Default text: anAlternative |

WML transformation

<p>
<img align=“alignment” alt=“alternative” height=“height” width=“width”

vspace=“vertSpace” hspace=“horizSpace” src=“location”/>

</p>

cHTML transformation

<BODY>
<BR clear=“all”>
<IMG align=“alignment” alt=“alternative” height=“height” width=“width”

vspace=“vertSpace” hspace=“horizSpace” src=“location”>

</BODY>

10. <label>

Description: This element is used create a label. A label can be used as a “title” to a <menu>, <list>, or <table> element. It can also be used to create a prompt for a <textInput> element. One or more <label> elements can be contained per <card>.

When Used: A label is used to introduce an input or to display an output. For example a label could be used to describe an input field such as “Name” or “Address”. Alternatively a label can be used to describe a table or a list.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this label element in |
| | the Project View panel of mBuilder. |
| Text | Holds text to be displayed. |
| Text Style | Holds the text format of the text to be displayed. Valid |
| | options: plain\|bold\|italics\|underline\|big\|small. |
| | Default: plain. This attribute is ignored in cHTML. |
| Text Color | Holds color of the text to be displayed. Valid options: |
| | black\|green\|silver\|lime\|gray\|white\|yellow\|maroon |
| | \|navy\|red\|blue\|purple\|teal\|fuchsia\|aqua. Default: |
| | browser default. This attribute is ignored in WML. This |
| | attribute is not available on all iMODE devices. |
| Alignment | Indicates text alignment. Valid options: left\|center\| |
| | right. |
| | Default: left. |

WML transformation

Note: each label transformation is assumed to start on a new line.

<p align = “align“>
<b|i|u|big|small>
“text“
</b|i|u|big|small>
</p>

cHTML transformation

Note: each label transformation is assumed to start on a new line.

Note: the cHTML DTD did not specify how the <FONT> tag is contained.

The transformations below need to be confirmed.

<BODY>
<DIV align=“align”>
<FONT color=“colorSelect”> “text”</FONT>
</DIV>
</BODY>

11. <link>

Description: This element is used to create a link. One or more <link> elements can be contained per <card>.

When Used: A link is used as a navigation mechanism to user to redirect the browser on the device to another location when selected.

Attributes:

| ID | Unique ID selected and used internally by mBuilder. |
|---|---|
| Element Label | mBuilder chooses a default value for this attribute, |
| | however the developer can overwrite it. The developer |
| | will see this label associated with this link element in the |
| | Project View panel of mBuilder. |
| Title | REQUIRED: Brief text identifying the link. |
| Hyperlink | REQUIRED: Destination URL. Default: anURL |
| Access Key | Holds the specified “hotkey” for this link. Valid options: |
| | 0-9, *, # |

WML transformation

<p>
<a href=“url” accesskey=“accessKey” title=“title”/>
</p>

cHTML transformation

<BODY>
<A href=“url” accesskey=“accessKey”>“title”</A><BR>
</BODY>

12. <list>

Description: This element is used to display a list of items. If the list of items to be displayed is dynamically generated, the Xpath for the list should be stored in the Dynamic List Source attribute. If list items to be displayed are always the same, a separate listItem element can be used to represent each item. A <list> can contain zero or more <listItem> elements.

Note: Nothing is displayed on the Simulator for a <list> element. Only static data stored in <listItem> elements are displayed. To validate how dynamic data is displayed, use sample data in <listItem> elements contained in a <list>. This static data will not be displayed at runtime.

When Used: List should be used if a list of items is to be displayed to the user. For example a grocery list, or a list of what was purchased.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this list element in the |
| | Project View panel of mBuilder. |
| Sorted | If the value of this attribute is “true”, items in this list |
| | will be preceded by numbers starting from “1”. |
| | Otherwise, items are preceded by bullets. Valid options: |
| | true\|false. Default: false. |
| Dynamic List | Holds the xpath (schema) of the list items if the list is to |
| Source | be generated dynamically. |
| | Note: If this attribute has been filled, static data in the |
| | listItem elements contained in this will be visible in the |
| | Smart Canvas for UI validation, but will not be seen at |
| | runtime. |

WML transformation

See listItem transformation.

See listItem transformation

13. <listItem>

Description: This element is used to define a single list item. To dynamically display a list of items to the user, use <list>. A <listItem> must be contained within a <list>. One or more <listItem> elements can be contained in a <list>.

When Used: A list item is used to display a specific list item.

Attributes: cHTML transformation

| | |
|---|---|
| ID | Unique ID selected and used internally by mBuilder. |
| Element Label | mBuilder chooses a default value for this attribute, |
| | however the developer can overwrite it. The developer |
| | will see this label associated with this listItem element in |
| | the Project View panel of mBuilder. |
| Title | Specifies the title of this list item. |

WML transformation

If “sorted” is “false” precede each listItem with a “bullet”:
<p> </br>
<big><b> <b></b> “title”</br>

......

</p>
If “sorted” is “true” hardcode numbers in ascending order for each listItem.
<p> </br>
1. “ title” </br>

......

</p>

cHTML transformation

If “sorted” is “false” use cHTML <UL> tag before all <LI> tags for each
listItem.
<UL>
<LI> “title” <\LI>

......

</UL>
If “sorted” is “true” use cHTML <OL> tag before all <LI> tags for each
listItem.
<OL>
<LI>“title”<\LI>

......

</OL>

14. <menu>

Description: This element is used to create a menu. Menu elements are used to provide a selection of menu items with hyperlinks to other pages. A <menu> element can contain multiple <menuItem> elements, but only one <menuItem> can be selected. When the user clicks on a <menuItem>, it navigates to the location which is specified by the hyperlink of the selected <menuItem>. To dynamically display menu items to the user, specify the appropriate Xpath in the Dynamic Data attributes described below.

Note: Nothing is displayed on the Simulator for a <menu> element. Only static data stored in <menuItem> elements are displayed. To validate how dynamic data is displayed, use sample data in <menuItem> elements contained in a <menu>. This static data will not be displayed at runtime.

When Used: A menu should be used if a selection of hyperlinks are to be displayed to the user. For example, a selection of restaurants.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this menu element in |
| | the Project View panel of mBuilder. |
| Variable Name | REQUIRED: Name for the “Return Value” of the |
| | selected item. Default: aName. Please refer to the |
| | “menuItem” element definition section for more details. |
| Default Value | Holds the default “value” to be displayed. |
| | Note: for WML the default value is an attribute to |
| | <select>. For cHTML the default value is an attribute to |
| | <option>. |
| Dynamic Text | Holds the xpath (schema) for menultems if the “title” for |
| Source | menuItems are dynamically displayed. |
| | Note: If this attribute has been filled, static data in the |
| | menuItem elements contained in this will be visible in |
| | the Smart Canvas for UI validation, but will not be seen |
| | at runtime. |
| Dynamic Value | Holds the xpath (schema) for menuItems if the “value” of |
| Source | menuItems are dynamically supplied. |
| | Note: If this attribute has been filled, static data in the |
| | menuItem elements contained in this will be visible in |
| | the Smart Canvas for UI validation, but will not be seen |
| | at runtime. |
| Dynamic | Holds the xpath (schema) for menuItems if the “url” for |
| Hyperlink | menuItems are dynamically supplied. |
| Path | Note: If this attribute has been filled, static data in the |
| | menuItem elements contained in this will be visible in |
| | the Smart Canvas for UI validation, but will not be seen |
| | at runtime. |

WML transformation

<p>
<select name=“name” value=“default”>

....

</select>
</p>

cHTML transformation

No cHTML tags are generated for this <menu> element. See “menuItem” element definition below. Note: The “default” attribute is ignored for this type of transformation.

15. <menuItem>

Description: This element is used as a specific menu item for a previously defined “menu” element. To dynamically display <menuItems>, use the <menu> element.

Note: Title and Element Label should be the same, and both should not be empty. If the value of either one changes, the other should be updated to reflect the change.

When Used: A menu item is used to provide a navigational selection to the user. When selected, the browser will be redirected to the hyperlink stored in the Hyperlink attribute.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this menuItem element |
| | in the Project View panel of mBuilder. |
| Title | REQUIRED: Holds the text to display for this menu |
| | item. |
| Return Value | Holds the value to be stored in the <menu> element |
| | attribute “Variable Name” when this menu item is |
| | selected |
| Hyperlink | REQUIRED. Holds the URL the browser is to be |
| | redirected to if this menu item is selected. |

WML transformation

The WML <option> tag generated for each <menuItem> element can be contained within the WML <select> tag if contained in a mBuilder <menu> element, or within an <optgroup> tag if contained in a <subMenu> element.

<option onpick = “url” value = “value”>“title”</option>

cHTML transformation

A cHTML <A> tag should be used for each <menuItem> specified.

<BODY>
<A href=“url”> “title”</A><BR>
<BODY>

16. <submenu>

Description: This element is used create a submenu. Submenus can be used to create a hierarchy of selection. <subMenu> s can only be contained in <menu>. <menuItem> can be contained in <submenu> or <menu>.

Note: this element is not provided in Beta Release. Do not document in Reference Manual for Beta.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this subMenu element |
| | in the Project View panel of mBuilder. |
| Title | REQUIRED: Title for this subMenu. Default: aTitle |

WML transformation

A WML <optgroup> tag will be generated for each <subMenu> element. Each <optgroup> tab will be contained within the WML <select> tag generated for the <menu> element. Each <menuItem> contained in this <subMenu> will be contained within the WML <optgroup> tag.

<select name=“name” value=“default” multiple=“multiple”>
<optgroup title=“title”>

....

</optgroup>

....

</wml>

cHTML transformation

Each <subMenu> element is implemented with an cHTML <A> tag which links the browser to the <menuItem> s contained in this <subMenu>.

1) If no urls are specified for all <menuItem> s in the <subMenu>, each <menuItem> is implemented using the cHTML <OPTION> tag. (see <menuItem> section above for more details). All <OPTION> tags for this <subMenu> are contained in a cHTML <SELECT> tag that uses the <menu> element attributes “name” and “multiple”. (See <menu> section above for more details).

Note: For each <subMenu> a separate cHTML <SELECT> tag is created which uses the same variable “name”.

If the “multiple” attribute is “true” then the cHTML multiple keyword also appears within the <SELECT>.

<BODY>

....

<A href=“#'title”> “title”</A><BR>

....

<A name-=“title”> </A>

<SELECT name=“name” multiple>
<OPTION value“value” selected> “title”
....
</SELECT><BR>
....

<BODY>

2) If urls are specified for <menuItems> within the same <subMenu> the cHTML <A> is used for the <subMenu> as well as for the <menuItem>. See example 2 in the cHTML transformation subsection of the <menuItem> element description section above for more details.

<BODY>

....

<A href=“#'title”> “title”</A><BR>

....

<
<A name=“title”></A>

<A href=“url”> “title”</A><BR>
....

<BODY>

17. <project>

Description: This element is used to store project level information. One or more deck can be contained in a project. There is only one instance of a project element per project and is created on behalf of the user by HP mBuilder.

Note: element counts are not visible to the developer. Do not document in Reference Manual.

When Used: The project element is modified if the developer want to change the project attributes which where defined when the project was created.

Attributes:

| | |
|---|---|
| ID | Unique project ID selected and used internally by |
| | mBuilder. |
| Element Label | This attribute has the same value as Project Name. The |
| | developer will see this label associated with this element |
| | in the Project View panel of mBuilder. |
| Project Name | REQUIRED: Project name assigned by developer. No |
| | default is given here. The developer will not be able to |
| | create a project without a projectName. |
| Home | REQUIRED: Complete path name of the project. The |
| Directory | developer will be required to provide this data. |
| Device | Device Category. Valid options: any\|wml\|chtml |
| Category | Default: any |
| Device List | Device List. Multiple devices can be selected and thus |
| | stored in the attribute. Valid options: TBD |
| | Default: TBD |
| blinkCnt | Counter used to generate mBuilder unique ID |
| buttonCnt | Counter used to generate mBuilder unique ID |
| cardCnt | Counter used to generate mBuilder unique ID |
| checkBox- | Counter used to generate mBuilder unique ID |
| Count | |
| checkBox- | Counter used to generate mBuilder unique ID |
| GroupCount | |
| choiceboxCnt | Counter used to generate mBuilder unique ID |
| choicebox- | Counter used to generate mBuilder unique ID |
| GroupCnt | |
| deckCnt | Counter used to generate mBuilder unique ID |
| elementCnt | Counter used to generate mBuilder unique ID |
| eventCnt | Counter used to generate mBuilder unique ID |
| imageCnt | Counter used to generate mBuilder unique ID |
| labelCnt | Counter used to generate mBuilder unique ID |
| linkCnt | Counter used to generate mBuilder unique ID |
| listCnt | Counter used to generate mBuilder unique ID |
| listItemCnt | Counter used to generate mBuilder unique ID |
| marqueeCnt | Counter used to generate mBuilder unique ID |
| menuCnt | Counter used to generate mBuilder unique ID |
| menuItem | Counter used to generate mBuilder unique ID |
| radioCnt | Counter used to generate mBuilder unique ID |
| radioGCnt | Counter used to generate mBuilder unique ID |
| servParmCnt | Counter used to generate mBuilder unique ID |
| subMenuCnt | Counter used to generate mBuilder unique ID |
| tableCnt | Counter used to generate mBuilder unique ID |
| tableCellCnt | Counter used to generate mBuilder unique ID |
| templateCnt | Counter used to generate mfluilder unique ID |
| textInCnt | Counter used to generate mBuilder unique ID |
| textOutCnt | Counter used to generate mBuilder unique ID |
| timerCnt | Counter used to generate mBuilder unique ID |
| variableCnt | Counter used to generate mBuilder unique ID |
| wmlButtonCnt | Counter used to generate mBuilder unique ID |

WML transformation

None.

CHTML transformation

None.

18. <radiobutton>

Description: This element is used define a radio button item.

Note:

1) For cHTML, an actual “radio button” is visible to the user with this element. Since WML does not implement a radio button, only the title is displayed in a multiple selection list on most simulators.

2) <radiobutton> must be contained within a <radiobuttonGroup>

3) Only one <radiobutton> can be selected within one <radiobuttonGroup>

4) Title and Element Label should be the same, and both should not be empty. If the value of either one changes, the other should be updated to reflect the change.

When Used: Radiobutton should be used if:

1) The UI presented to the developer should visually look like a radio button on cHTML devices vs. a multiple list selection.

2) The user is only allowed to select one of <radiobutton> items in a <radiobuttonGroup>.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this radiobuttton |
| | element in the Project View panel of mBuilder. |
| Title | REQUIRED: Text to be displayed for this radio button |
| | element. |
| Selected | Indicates whether the <radiobutton> is selected. Valid |
| | options: true\|false. Default: false |
| Return Value | Value to be stored in “Variable Name” attribute of this |
| | radiobutton's radiobuttonGroup if this item is selected. |

WML transformation

<option value = “value”>“title”</option>

cHTML transformation

see <radiobuttonGroup> for transformation.

19. <radiobuttonGroup>

Description: This element is used as a container for one or more <radiobutton> elements. To dynamically display a group of choice boxes to the user, store the Xpath for the title/value pairs of the checkboxes to be displayed in the Dynamic attributes described below

Note: Nothing is displayed on the Simulator for a radiobuttonGroup element. Only static data stored in <radiobutton> elements are displayed. To validate how dynamic data is displayed, use sample data in <radiobutton> elements contained in a <radiobuttonGroup>. This static data will not be displayed at runtime.

Implementation Note: Only one <radiobutton> can be checked at any time. If a <radiobutton> is selected by the user, <radiobuttonGroup> should unchecked the previous checked <radiobutton> to comply with the “ONLY ONE” rule.

When Used: radiobuttonGroup should be used if:

1) The UI presented to the developer for the radiobuttons in the group should visually look like “radiobuttons”.

Note: for WML, radiobutton elements may be rendered as a multiple selection list on some devices. To allow for the same “look and feel” on both WML and cHTML devices please refer to the ChoiceBoxGroup element definition.

2) The user is allowed to select only one radiobutton. An example might be a radiobutton selection of colors for a given item.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this radiobuttonGroup |
| | element in the Project View panel of mBuilder. |
| Variable Name | REQUIRED: Name to store the selected <radiobutton> |
| | “Return Value” in. Default: aName |
| Dynamic Text | Holds the xpath (schema) of title attribute if a group of |
| Source | radioButtons is dynamically displayed. |
| | Note: If this attribute has been filled, static data in the |
| | radioButton elements contained in this will be visible in |
| | the Smart Canvas for UI validation, but will not be seen |
| | at runtime. |
| Dynamic Value | Holds the xpath (schema) of the value attribute if a |
| Source | radiobutton in a radioButton Group is to be dynamically |
| | supplied. |
| | Note: If this attribute has been filled, static data in the |
| | radioButton elements contained in this will be visible in |
| | the Smart Canvas for UI validation, but will not be seen |
| | at runtime. |

WML transformation

For WML all <radiobutton> elements must be contained within the same <select> tag. A <radiobutton> transformation (i.e. WML <option> tag) is included in the transformation below for completeness. “value” should have the same value as that of the selected <radiobutton>.

Note: The “multiple” tag attribute is “false” by default, which means it does not allow the list to accept multiple options simultaneously selected.

<select name=“name” value=“[value of the selected <radiobutton>]”>
<option value=“value”>“title”</option>

....
</select>

cHTML transformation

For cHTML all <radiobutton> elements will be contained within the same <FORM> tag which was generated at the <card> level. Note: The same “name” value taken from the “name” attribute in <radiobuttonGroup> is used for every <radiobutton> transformation.

Note: The cHTML “checked” attribute is only used for the cHTML <INPUT> transformation whose “checked” attribute is “true”.

<INPUT type =“radio” name=“name” value=“value” checked>“title”<BR>

20. <serverParameter>

Description: This element is used to specify a parameter to be sent to the server.

Note:

1) The <serverParameter> element must be contained in a <button> element of type “submit”. Otherwise it will not be processed.

2) Note: multiple <serverParameter> elements can be contained within a single <button> element

When Used: Server Parameters are used to pass user visible input variables and their values (e.g. TextInput) to the server. To pass name/value pairs which should not be visible to the user (e.g. server cookies, user ids) use the Hidden Variable element.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this serverParameter |
| | element in the Project View panel of mBuilder. |
| Parameter | REQUIRED: Name of variable to be passed to server. |
| Name | Default: aName |
| Parameter | REQUIRED: Value to be assigned to “name” attribute |
| Value | when passed to server. Default: aValue |
| | Note: For WML devices, the name of the variable |
| | stored in the “Parameter Name” attribute of |
| | <serverParamater> can also be stored in this “Parameter |
| | Value” attribute. If this is done, the server will receive a |
| | name/value pair which contains the Parameter Name, and |
| | the contents of the Parameter Name. This type of |
| | functionality is not supported on cHTML. For cHTML, |
| | the name/value pair sent to the server will be Parameter |
| | Name and Parameter Name. |
| valueXpath | Holds the xpath (schema) of the “Parameter Value“ |
| | attribute. Note: this attribute is not provided in Beta. |
| | Note: If this attribute has been filled, data stored in the |
| | Parameter Value will not be used at runtime. |

WML transformation

1. A WML <postfield> tag will be generated for each <serverParameter> element. Since the <serverParameter> element must be contained in a <button> element with attribute type=“submit”, the <postfield> will be embedded within the <go> tag generated for the <button> element. The translation below includes the <button> translation for completeness. See the <button> element description for more information.

<do label = “label” type = “accept”>

<go method=“post” href=“url”>
<postfield name=“name” value=“value”/>
......

</go>

</do>

2. If both the “name” and “value” attributes contain the same variable name, the contents of the variable name stored in the “value” attribute will be passed to the server. Being able to put a variable name into the “value” attribute of <serverParameter> is provided so the contents of a WML variable can be passed to the server. Examples are:

a) The variable stored in the “name” attribute for the <textInput>, <menu>, or <radio> elements.

b) The variable stored in the “title” attribute for the <menuItem> element. Transformation is:

<do label = “label” type=“accept”>

<go method=“post” href=“url”/>
<postfield name=“name” value=“$value”/>
......
</go>

</do>

cHTML transformation

1. An <INPUT> tag is generated for each <serverParameter> element. Since the <serverParameter> element must be contained in a <button> element with attribute type=“submit”, the <INPUT> tag will be included within the cHTML <FORM> tag generated for the <card> element. The translation below includes the <button> translation for completeness. See the <button> element description for more information.

Note: a cHTML “hidden” attribute is used here since <serverParameter> is used to pass additional parameters to the server which are not already being passed via normal <INPUT type=“(text|passwd|radio)”> definitions through mBuilder <textInput>, and <radiobutton> elements.

<FORM method=“post” action = “url”>
<INPUT type=“hidden” name=“name” value=“value”>

......

<INPUT type = “submit” value = “label”> </BR>
</FORM>

2. If both the “name” and “value” attributes contain the same variable name, this <serverParameter> element will not be translated (i.e. it will be ignored) for cHTML. Being able to put a variable name into the “value” attribute of <serverParameter> is provided so the contents of WML <input> or <select> tags can be sent to the server. Since cHTML can pass <INPUT> and <SELECT> items directly through the cHTML <FORM> tag this capability is not needed for cHTML.

21. <table>

Description: This element is used to create a table. To dynamically display data with a table, please refer to the tableCell element description below. A table can contain one or more <tableCell> elements.

WARNING: since cHTML does not implement “table, how this <table> element is displayed on iMODE devices could vary widely.

Note: Nothing is displayed on the Simulator for a table element. Only static data stored in <tableCell> elements are displayed. To validate how dynamic data is displayed, use sample data in <tableCell> elements contained in a <table>. This static data will not be displayed at runtime.

When Used: This element is used if multiple columns of data are to be displayed. For example stock quotes.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this table element in |
| | the Project View panel of niBuilder. |
| Alignment | Valid options: left\|center\|right. Default: left |
| Row Count | Number of rows in the table. For dynamically generated |
| | tables, this attribute can be left undefined. |
| | Note: this attribute is not provided in Beta. |
| | Note: This attribute can also be used by mBuilder to |
| | determine (1) If the table created will be too big for the |
| | memory available for the device target specified when |
| | the project was created. (2) To cross check the number |
| | of <tableCells> defined does not exceed the number of |
| | rows expected. |
| Column Count | REQUIRED: Number of cells per row. (i.e. expected |
| | number of columns per row) Default: 1 |

WML transformation

<table align=“alignment” columns=“columnCnt”/>

....

</table>

cHTML transformation

<P align=“alignment”>

....

</P>

22. <tableCell>

Description: This element is used to specify the data displayed in a table. Since the number of columns in the table is defined in the <table> element, mBuilder “knows” how many <tableCells> to display per row. For example, if the developer defines a <table> with attribute “Column Count” set to 2, and then defines 3 <tableCell> elements contained in a <table> element, mBuilder will put the contents of the first two <tableCell> elements in the first row, and the content of the third <tableCell> as the first item in the second row.

For example:

| | |
|---|---|
| Text1 | Text2 |
| Text3 | |

Note:

1) tableCells can only be contained within a <table> element.

2) To dynamically display data, specify the data's Xpath in the Dynamic Data Source attribute below. Note: Nothing is displayed on the Simulator for a table Cell element if nothing has been specified in the “Text” attribute. To validate how dynamic data is displayed, use sample data in “Text” attribute. This static data will not be displayed at runtime.

When Used: A table cell is used to display data within a table.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this tableCell element |
| | in the Project View panel of mBuilder. |
| Text | Text to be displayed in this cell. |
| Dynamic Data | Holds the xpath (schema) of the data if the tableCell is |
| Source | dynamically displayed. Note: this attribute only needs to |
| | be set by the developer once per column. So for the |
| | example table above, the developer would set this |
| | “xpath” attribute for the Text1 and Text2 cells above. |
| | Setting the “xpath” attribute for Text3 is not necessary. |
| | Note: If this attribute has been filled, static data in the |
| | “text” attribute above will be visible in the Smart Canvas |
| | for UI validation, but will not be seen at runtime. |

WML transformation

In WML, each <tableCell> item within a row must be contained within the WML <tr> tags which are contained with the WML <table> tags represented in the “WML transformation” subsection of the <table> element section above.

<table align=“alignment” columns=“columnCnt”/>
<tr>

<td>“text”</td>
....

</tr>
</table>

cHTML transformation

For cHTML, each <tableCell> will be “handcrafted” by mBuilder using blank spaces between <tableCell> “text” attributes. cHTML <BR> tags will be used to start new rows. All “handcrafted” <tableCell> elements will be contained within the cHTML <P> tag as represented in the “cHTML transformation” subsection of the <table> element section above.

<P align=“alignment”>
“text”<BR>

....

</P>

23. <textInput>

Description: This element is used to receive text or password input from the user.

When Used: Use this element to receive input from the user. For example a user name or a user password.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this textInput element |
| | in the Project View panel of mBuilder. |
| Text Type | Specifies type of input to be received. Valid options: |
| | text\|password. Default: text. |
| Variable Name | REQUIRED: Name of variable to contain user input. |
| | Default: aName |
| Display Length | Width of input field in characters. |
| Format | Specifies format of input to be received. Valid options: |
| | any\|alpha\|\|num. Default: any. |
| | Note: the format specified is not necessarily enforced |
| | by the browser. |
| | Note: this attribute is not supported on all iMODE |
| | devices. |
| | Note: “alpha” is not supported in Beta due to some |
| | WML transformation limitation. |
| Maximum | Specifies maximum field length. |
| Length | |
| Default Value | Default value assigned to “name” attribute if not |
| | initialized. |

WML transformation

If “format” is “num”, use “*N”, if “format” is “alpha”, use “*a”, otherwise use “*M”. If “maxlength” is specified the numer of “M”s, “a”s, or “N”s should reflect “maxlength”. For example if maxlenth=3, the transformation for format “num” would show three N's(“NNN”) instead of *N.

<p>
<input type=“type” name=“name” size=“size” format=“(*M|*a|*N)”

maxlength=“maxlength” value=“default”/>

</p>
For example, social security number could be formatted as “NNN-NN-
NNNN”.

cHTML transformation

The “istyle” attribute sets the default character input mode (alphabetic, numeric, etc.) as follows:

| | | |
|---|---|---|
| Attribute | Mode 1 (When in | Mode 2 (When in pager |
| value | kana input mode) | message input mode) |

| | | |
|---|---|---|
| 1 (default) | Full-space kana | Full-space characters |
| 2 | Half-space kana | Half-space characters |
| 3 | Alphabetic | Half-space characters |
| | | (Lower case |
| | | recommended) |
| 4 | Numeric | Half-space characters |
| | | (Numeric recommended) |

The istyle attribute is not applicable to INPUT type=“password,” whose input mode is always fixed as numeric.

If “format” is “num”, set “istyle” attribute to 4, if “format” is “alpha”, set
“istyle” attribute to 3, otherwise don't use “istyle” (i.e. use the default).
<INPUT type=“type” name=“name” “istyle=“3|4”

maxlength=“maxlength” value=“default”>

24. <textOutput>

Description: This element is used to display text to the user. To dynamically display text to the user, use the Dynamic Data attribute defined below.

When Used: Use to display text on the device.

Attributes:

| | |
|---|---|
| ID | Unique ID selected and used internally by mBuilder. |
| Element Label | mBuilder chooses a default value for this attribute, |
| | however the developer can overwrite it. The developer |
| | will see this label associated with this textOutput element |
| | in the Project View panel of mBuilder. |
| Text | Holds text to be displayed |
| | Note: To display the contents of an input variable use |
| | the following syntax: $(variable_name) |
| Text Style | Holds the text format of the text to be displayed. Valid |
| | options: bold\|italics\|underline\|big\|small. |
| | Default: no formatting. This attribute is ignored in |
| | cHTML. |
| Text Color | Holds color of the text to be displayed. Valid options: |
| | black\|green\|silver\|lime\|gray\|white\|yellow\| |
| | maroon\|navy\|red\|blue\|purple\|teal\|fuchsia\| |
| | aqua. Default: browser default. This attribute is ignored |
| | in WML. This attribute is not available on all iMODE |
| | devices. |
| Alignment | Indicates text alignment. Valid options: left\|center |
| | right. Default: left. This attribute is ignored if the |
| | “preformat” attribute is “true” |
| Wrapped | Indicates if text should wrap. Valid options: true\| |
| | false. Default: true. This attribute is ignored if the |
| | “preformat” attribute is “true“. For cHTML this attribute |
| | will always be “true” in version 1.0 of mBuilder. |
| Preformatted | Indicates text should be displayed as previously |
| | formatted. Valid options: true\|false. Default: false. |
| | Note: not this attribute is not available on cHTML |
| | devices and is not available on all WML browsers. |
| Dynamic Data | Holds the xpath (schema) of the text if the text is to be |
| Source | dynamically displayed. |
| | Note: If this attribute has been filled, static data in the |
| | “text” attribute above will be visible in the Smart Canvas |
| | for UI validation, but will not be seen at runtime. |

WML transformation

If the “preformat” attribute is “false” the following transformation should be used. If the “wrap” attribute is “true” use “wrap” for WML “mode” attribute. Otherwise use “nowrap”.

Note: each textOutput transformation is assumed to start on a new line.

<p align = “align” mode=“wrap|nowrap”>
<b|i|u|big|small>
“text”
</b|i|u|big|small>
</p>

If the “preformat” attribute is “true”:

<p>
<pre>
<b|u|big|small>
“text”
</b|i|u|big|small>
</pre>
</p>

cHTML transformation

If the “preformat” attribute is “false” the following transformations might be used.

Note: each textOutput transformation is assumed to start on a new line.

Note: the cHTML DTD did not specify how the <FONT> tag is contained. The transformations below need to be confirmed.

<BODY>
<DIV align=“align”>
<FONT color=“colorSelect”> “text”<FONT>
</DIV>
</BODY>

If the “preformat” attribute is “true”:

<BODY>
<FONT color=“colorSelect”>
<PRE>
“text”
</PRE>
</FONT>
</BODY>

What is claimed is:

1. A method of graphically generating a user interface using software, the software generating a user interface display having a first, second and third area comprising:
selecting an element to include in a user interface from the first area;
determining if the selected element is a common element or a specific element;
generating code based on the determination, wherein information associated with the generated code is displayed in the second area; and
testing the generated code in the third area.

2. The method of claim 1 wherein the generating code step further comprises:
locating code associated with the element in a database.

3. The method of claim 1 wherein the selecting an element step comprises:
receiving an indication that an element has been selected; and
displaying information associated with element in the second area.

4. The method of claim 1 wherein the step of determining if the selected element is a common element or a specific element further comprises:
locating information associated with the element in a database;
generating markup code, if it is determined that the element is a common element; and
generating markup code if it is determined that the element is a markup-specific element.

5. The method of claim 1 wherein the step of determining if the selected element is a common element or a specific element further comprises:
locating information associated with the element in a database; and
generating WML and CHTML code, if it is determined that the element is a common element.

6. The method of claim 5 further comprising:
generating WML code if it is determined that the element is a WML-specific element; and
generating CHTML code if it is determined that the element is a CHTML-specific element.

7. The method of claim 1 wherein the testing step further comprises:
displaying the generated code using a simulator.

8. The method of claim 7 wherein the simulator is an embedded simulator, an integrated simulator or an external simulator.

9. The method of claim 1 further comprising:
modifying the generated code in the second area based on information received from a user.

10. The method of claim 1 further comprising:
graphically generating a user interface associated with at least one mobile device, wherein the user interface includes the selected element;
testing the user interface with a simulator associated with the third area; and
updating the user interface based on results from testing the user interface in the simulator.

11. A method of creating a graphical user interface for at least one mobile device, comprising:
generating a first viewable area containing at least one selectable user interface element, wherein each user interface element is associated with code;
generating a second viewable area containing additional information associated with a selected user interface element;
generating a third viewable area for displaying a simulator that tests code associated with the selected user interface element; and
designing a graphical user interface for at least one mobile device using the first and second areas.

12. The method of claim 11 wherein the simulator is an embedded simulator, an integrated simulator or an external simulator.

13. The method of claim 11 wherein said designing a graphical user interface step further comprises:
dragging an element from the first area; and
dropping the element in the second area.

14. The method of claim 11 further comprising:
supplying code to a mobile device simulator;
specifying a simulator to simulate the code; and
simulating, with a specified mobile device simulator, a display of said mobile device, wherein said display includes a user interface based on said code.

15. A system for graphically generating a user interface, wherein the system generates a user interface display having at least first, second and third areas, the first area containing at least one selectable element, the system comprising:
receiving means for receiving a user's selection of an element to include in a user interface;
logic means for determining if the selected element is a common element or a specific element;
generation means for generating code associated with the element, wherein information associated with the generated code is displayed in a second area; and
a simulator configured to display test results of the generated code in a third area.

16. The system of claim 15 wherein the generating means further locates, in a database, code associated with the selected element.

17. The system of claim 15 wherein the receiving means further receives an indication that said element has been selected and wherein the system further includes display means for displaying information associated with said selected element in the second area.

18. The system of claim 15 wherein the logic means further locates information associated with the element in a database, wherein the generation means further generates markup code if it is determined that the element is a common element, and wherein the generation means further generates markup code if it is determined that the element is a specific element.

19. The system of claim 15 wherein the logic means further locates information associated with the element in a database, wherein the generation means further generates WML and CHTML code if it is determined that the element is a common element, and wherein the generation means further generates one of WML and CHTML code if it is determined that the element is a specific element.

20. The system of claim 19 wherein the generation means further generates WML code if it is determined that the element is a WML element, generates CHTML code if it is determined that the element is a CHTML element.

21. The system of claim 15 wherein the simulator further includes a simulator.

22. The system of claim 15 further comprising:
display means for displaying a user interface associated with at least one mobile device, wherein the user interface includes the selected elements; and
update means for updating the user interface based on results from testing the user interface in the simulator.

23. The system of claim 15 wherein the simulator is an embedded simulator, an integrated simulator or an external simulator.

24. A computer for creating a graphical user interface for at least one mobile device, the computer having at least one processor, at least one memory unit and at least one display unit, the computer further comprising:
means for generating and transforming code associated with elements in at least one markup language,
means for displaying information in a first area containing at least one selectable user interface element, wherein each user interface element is associated with code, that displays information in a second area including additional information associated with a selected user interface element, wherein the first and second area are used to design a graphical user interface; and
means for displaying in a third area output of an embedded simulator.

25. The computer of claim 24 further comprising:
means for dragging an element from the first area and dropping the element in the second area.

26. The computer of claim 24 further comprising:
means for testing the generated code using a mobile phone simulator.

27. The computer of claim 26 wherein the mobile phone simulator is an embedded simulator, an integrated simulator or an external simulator.

28. A markup language system, comprising:
a computer comprising:
a database including code associated with a first markup language and code transformations associated with a second markup language;
memory that contains instructions for: receiving an element selection selected by a user; determining if the element is a common element or a specific element; if the element is a common element, generating code and code transformations in the first and second markup languages; and if the element is a specific element, generating code in the first or second markup language; and
a processor connected to said memory and said database.

29. The system of claim 28 wherein the memory further contains instructions for: generating a user interface having a first, second and third viewable area, wherein the first viewable area contains common and specific elements; and determines if the element is common or specific by querying a database.

30. The system of claim 28 wherein the memory further contains instructions for:
displaying, in the second viewable area, the generated code.

31. A computer program product comprising computer-readable code stored on computer-readable medium, said computer program comprising:
code for generating a display having a first, second and third area;
code for selecting an element to include in a user interface from the first area;
code for determining if the selected element is a common element or a specific element;
code for generating code based on the determination, wherein information associated with the generated code is displayed in the second area; and
code for testing the generated code in the third area.

32. The computer program product of claim 31 wherein said code for generating computer code further comprises:
code for locating code associated with the element in a database.

33. The computer program product of claim 31 wherein the code for selecting an element step comprises:
code for receiving an indication that an element has been selected; and
code for displaying information associated with element in the second area.

34. The computer program product of claim 31 wherein the code for determining if the selected element is a common element or a specific element further comprises:
code for locating information associated with the element in a database;
code for generating markup code, if it is determined that the element is a common element; and
code for generating markup code if it is determined that the element is a markup-specific element.

35. The computer program product of claim 31 wherein the code for determining if the selected element is a common element or a specific element further comprises:
code for locating information associated with the element in a database; and
code for generating WML and CHTML code, if it is determined that the element is a common element.

36. The computer program product of claim 31 further comprising:
code for generating WML code if it is determined that the element is a WML-specific element; and
code for generating CHTML code if it is determined that the element is a CHTML-specific element.

37. The computer program product of claim 31 wherein the testing step further comprises:
code for displaying the generated code using a simulator.

38. The computer program product of claim 31 further comprising:
code for graphically generating a user interface associated with at least one mobile device, wherein the user interface includes the selected element;
code for testing the user interface with a simulator associated with the third area; and
code for updating the user interface based on results from testing the user interface in the simulator.

39. The computer program of claim 38 wherein the simulator is an embedded simulator, an integrated simulator or an external simulator.
